(19) United States
(12) Patent Application Publication
(10) Pub. No.: US 2004/0181601 A1
(43) Pub. Date: Sep. 16, 2004

(54) Peripheral device sharing

(76) Inventor: Palsamy Sakthikumar, Puyallup, WA (US)

Correspondence Address: BUCKLEY, MASCHOFF, TALWALKAR LLC, 5 ELM STREET, NEW CANAAN, CT, 06840, US

(21) Appl. No.: 10/389,213

(22) Filed: Mar. 14, 2003

(51) Int. Cl. G06F 15/16

(52) U.S. Cl. 709/229

(57) ABSTRACT

According to some embodiments, a device is provided to receive a request to provide a first client with access to a device, the device being accessed by a second client, and to tri-state a device signal transmitted between the device and the second client.

### BACKGROUND

Some computing architectures allow a group of clients to share one or more peripheral devices. A group of clients may include hardware elements as well as software applications executed by hardware elements. Current systems for sharing one or more peripheral devices are often inefficient or otherwise unsatisfactory.

In a specific example, a modular server includes several distinct servers, or blade servers. The blade servers are mounted in a chassis, which in turn is coupled to one floppy disk drive, one compact disc drive, one keyboard and one mouse via respective Universal Serial Bus interfaces. The blade servers therefore share these peripheral devices amongst themselves.

The chassis also includes a management module, which receives requests to access the peripheral devices from the other blade servers. After receiving a request to access a peripheral device, complex hardware logic of the management module generates activity on an appropriate bus to simulate unplugging the device from a current client and plugging the device into the requesting client. The operating system of the current client also must renumerate the entire bus and unload a driver associated with the requested device. Moreover, the requesting client must renumerate the bus and install a driver for the requested device.

### BRIEF DESCRIPTION OF THE DRAWINGS

FIG. 1 is a block diagram of a system according to some embodiments.

FIG. 2 is a flow diagram of a process according to some embodiments.

FIG. 3 is a block diagram of a system according to some embodiments.

FIG. 4 is a block diagram of a client device according to some embodiments.

FIG. 5 is a block diagram of a routing device according to some embodiments.

FIGS. 6A and 6B are views of a system according to some embodiments.

FIG. 7 is a diagram of a process according to some embodiments.

FIG. 8 shows representations of scheduling data structures according to some embodiments.

### DETAILED DESCRIPTION

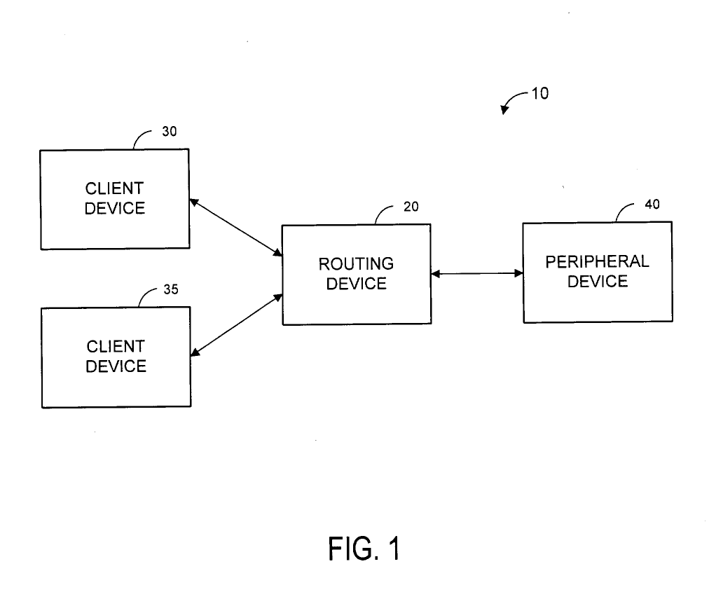

FIG. 1 is a block diagram of system 10. System 10 comprises routing device 20 in communication with client device 30, client device 35, and peripheral device 40. Routing device 20 may comprise any element or elements for providing services to clients, including but not limited to a server, a motherboard, a module, an expansion card, a controller, discrete logic, and software.

Client devices 30 and 35 may comprise any devices for receiving services of shared peripheral device 40. Examples of client devices 30 and 35 include a server, a personal computer, a personal digital assistant, and a cellular telephone. Clients according to some embodiments include client devices such as those described above as well as client software applications. In some embodiments, client devices 30 and 35 communicate with peripheral device 40 according to the USB protocol.

In this regard, peripheral device 40 may comprise a USB device such as a floppy disk drive, a compact disc drive, a keyboard and a mouse. Peripheral device 40 is coupled to routing device 20 in order to be shared among client devices 30 and 35 according to some embodiments.

The communication links shown in FIG. 1 may be any combination of media for transferring data, and need not be identical to one another. Possible media include coaxial cable, twisted-pair wire, backplane connectors, fiber-optics, RF signals, and infrared signals. Although each link appears dedicated, a link according to some embodiments comprises a bus that is shared among two or more of the illustrated and/or other unshown elements. Moreover, unshown elements may be disposed between elements of FIG. 1 that appear to be directly linked to one another.

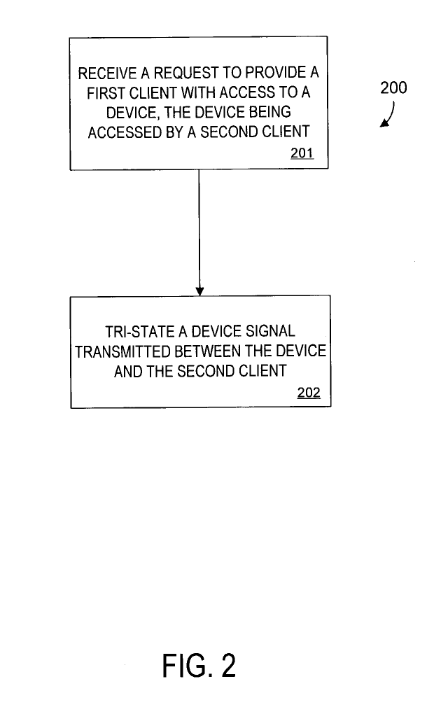

FIG. 2 is a flow diagram of process 200 that may be executed by routing device 20 according to some embodiments. Process 200 may be embodied by any combination of hardware or software. In some embodiments, process 200 is embodied by software stored in a memory and executed by a controller of routing device 20. Process 20 may provide peripheral device sharing that is more efficient than previously available.

A request to provide a first client with access to a device is received in 201, while the device is being accessed by a second client. In one example of 201, routing device 20 receives a request from client device 30 to access peripheral device 40 at a time when peripheral device 40 is being accessed by client device 35. According to some embodiments, client device 35 possesses ownership of peripheral device 40 on the appropriate bus when the request is received, and is not necessarily exchanging data with peripheral device 40 at the exact time at which the request is received.

Next, in 202, a device signal transmitted between the device and the second client is tri-stated. In the present example, device 40, client device 35, and device 30 are each in communication with a same bus, therefore a same device signal is transmitted between peripheral device 40 and client device 35 as is transmitted between peripheral device 40 and client device 30. Routing device 20 tri-states the device signal that is transmitted between peripheral device 40 and client device 35 in 202. Further details of operation according to some embodiments are provided below.

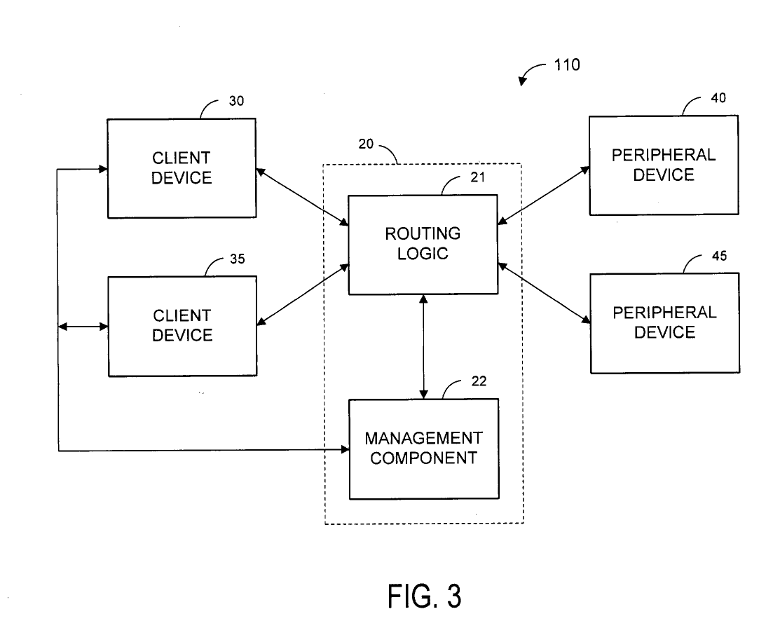

FIG. 3 is a block diagram of system 110 according to some embodiments. Routing device 20 of system 110 includes routing logic 21 and management component 22. Routing logic 21 may comprise hardware to tri-state a device signal as described with respect to step S202. Management component 22 may comprise a software application and/or hardware to execute a software application. Management component 22 may be used to receive requests from clients and to indicate a device signal to tri-state to routing logic 21.

System 110 includes peripheral device 45, which may be identical to or different from peripheral device 40. Peripheral device 45 may communicate with clients via any protocol, including USB. Some embodiments may include more than two peripheral devices, and/or more than two clients.

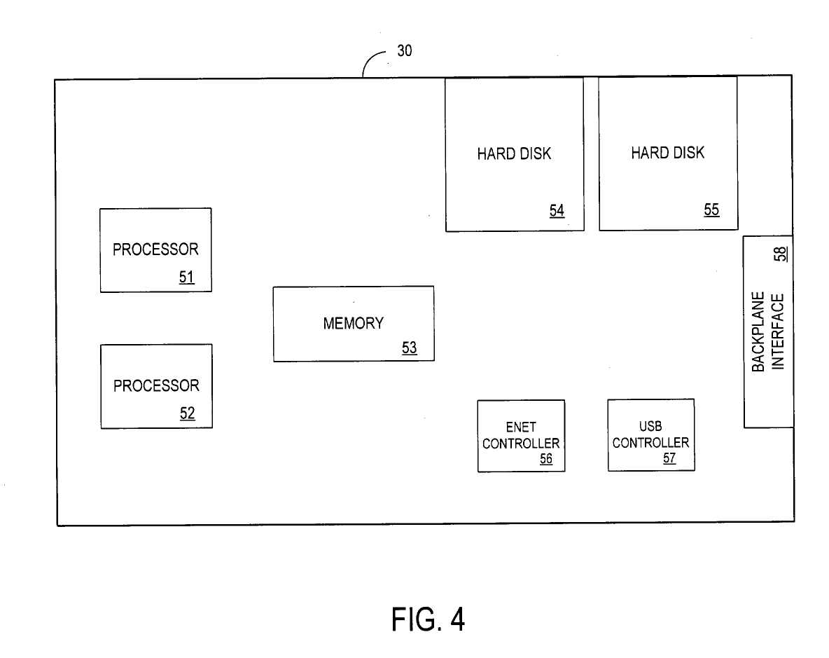

FIG. 4 is a block diagram of client device 30 according to some embodiments. Client device 30 of FIG. 4 comprises a hardware server packaged within a thin enclosure, and therefore referred to as a blade server.

Client device 30 includes processors 51 and 52, such as Intel Xeon™ processors. Processors 51 and 52 are coupled to Double Data Rate Random Access Memory 53. Memory 53 may store scheduling data structures that are used to execute transactions with peripheral devices. These data structures according to some embodiments are described in more detail below.

Memory 53 may also store executable program code. In operation, stored program code transferred from memory 53 to on-board or external memory caches of processors 51 and 52 and are executed therefrom. The program code may comprise a software application and may be received from media external to client device 30.

Software applications may be stored for extended periods in hard disk drives 54 and 55. Also stored in hard disk drives 54 and 55 may be data files, device drivers, and an operating system for controlling basic functions of client device 30. The device drivers may include device drivers for peripheral devices, and the operating system may include a USB driver.

Ethernet controller 56 allows client device 30 to communicate with other devices via Ethernet protocol. Similarly, USB controller 57 provides communication with USB devices according to a USB specification, such as the Universal Host Controller Interface (UCHI) Design Guide, rev. 1.1. USB controller 57 may include memory registers (not shown) to store configuration information such as a Frame List Base Address Register and a Frame Counter. This information may be used to locate scheduling data structures stored in memory 53.

The USB devices and other devices may be coupled to client device 30 using backplane interface 58. In some embodiments, backplane interface 58 couples client device 30 to a backplane to which is also coupled other client devices, routing device 20 and various peripheral devices. Client device 30 need not include each element shown, and may include elements other than those shown.

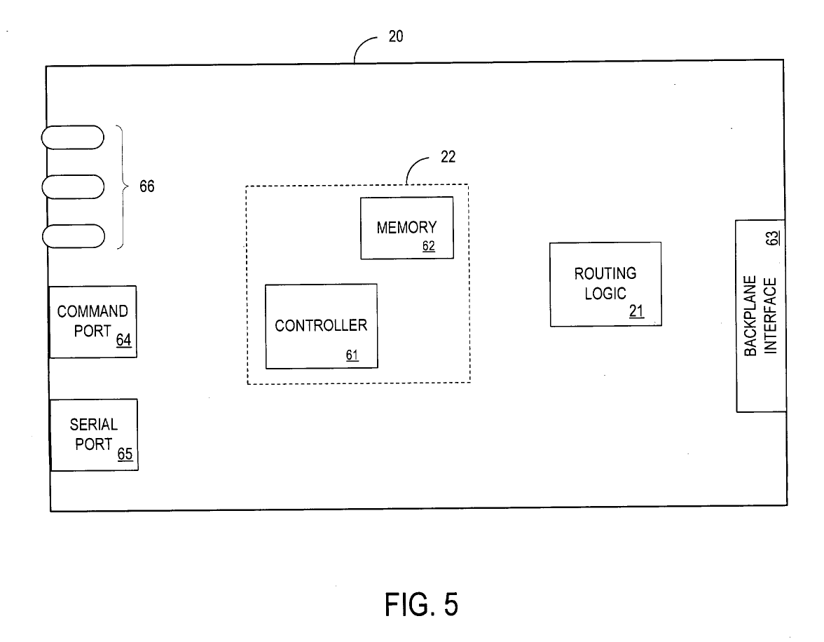

FIG. 5 is a block diagram of routing device 20 according to some embodiments. Routing device 20 of FIG. 5 comprises a blade server management module. Routing device 20 may comprise implementations and combinations of hardware and/or software other than that shown in FIG. 5.

As shown in FIG. 3, routing device 20 includes routing logic 21 and management component 22. Routing logic 21 may comprise discrete logic elements to tri-state signals transmitted between a peripheral device and all but one client device. Management component 22 includes controller 61 and memory 62. Controller 61 may execute process steps stored in memory 62 to receive requests from clients and to indicate to routing logic 21 a device signal to tri-state.

Routing device 20 is coupled to peripheral device 40 and to client devices 30 and 35 via backplane interface 63. In this regard, routing logic 21 or management component 22 may be implemented in a backplane to which backplane interface 63 is coupled. Operator commands and/or program code may be transmitted to routing device 30 through command port 64 and/or serial port 65. Diagnostic lights 66 may comprise light-emitting diodes for indicating various statuses of routing device 20 to an operator.

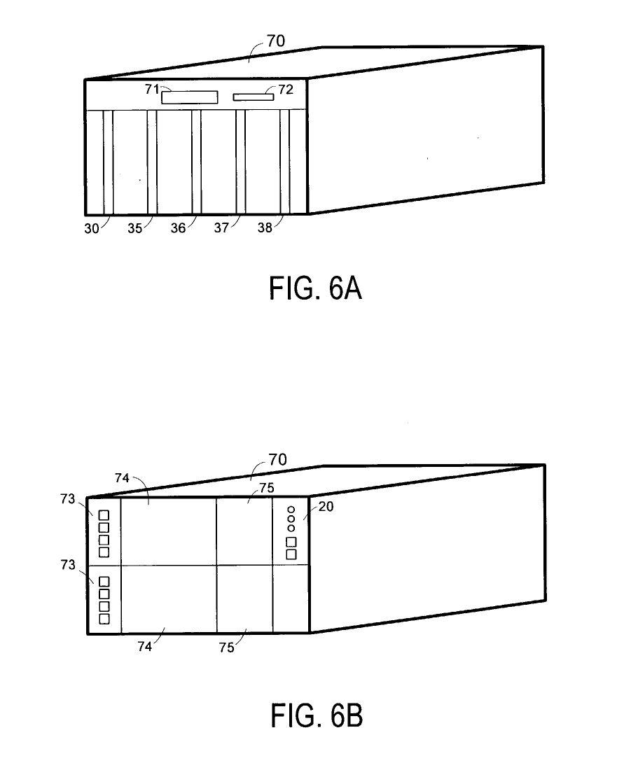

FIGS. 6A and 6B are views of a system according to some embodiments. As shown in FIG. 6A, system 70 comprises a chassis in which are mounted client devices 30, 35, 36, 37 and 38. Client devices 30, 35, 36, 37 and 38 are blade servers similar to that illustrated in FIG. 4. Client devices 30, 35, 36, 37 and 38 are coupled via respective backplane interfaces to a midplane, which is a type of backplane that is located within the chassis.

System 70 also comprises peripheral devices 71 and 72. In some embodiments, peripheral devices 71 and 72 are a USB CD-ROM drive and a USB floppy disk drive, respectively. Peripheral devices 71 and 72 may be shared among client devices 30, 35, 36, 37 and 38 according to some embodiments.

FIG. 6B is a rear view of system 70. Shown are switch modules 73 for redundant support of Gb Ethernet and Fibre Channel connections. Also shown are redundant blower modules 74 and redundant power supply modules 75. Each of modules 73 through 75 are coupled to the above-described midplane such that their services may be shared among client devices 30, 35, 36, 37 and 38. FIG. 6B also shows routing device 20 implemented as a blade server management module. Routing device 20 of FIG. 6B provides shared access of peripheral devices 71 and 72 to client devices 30, 35, 36, 37 and 38.

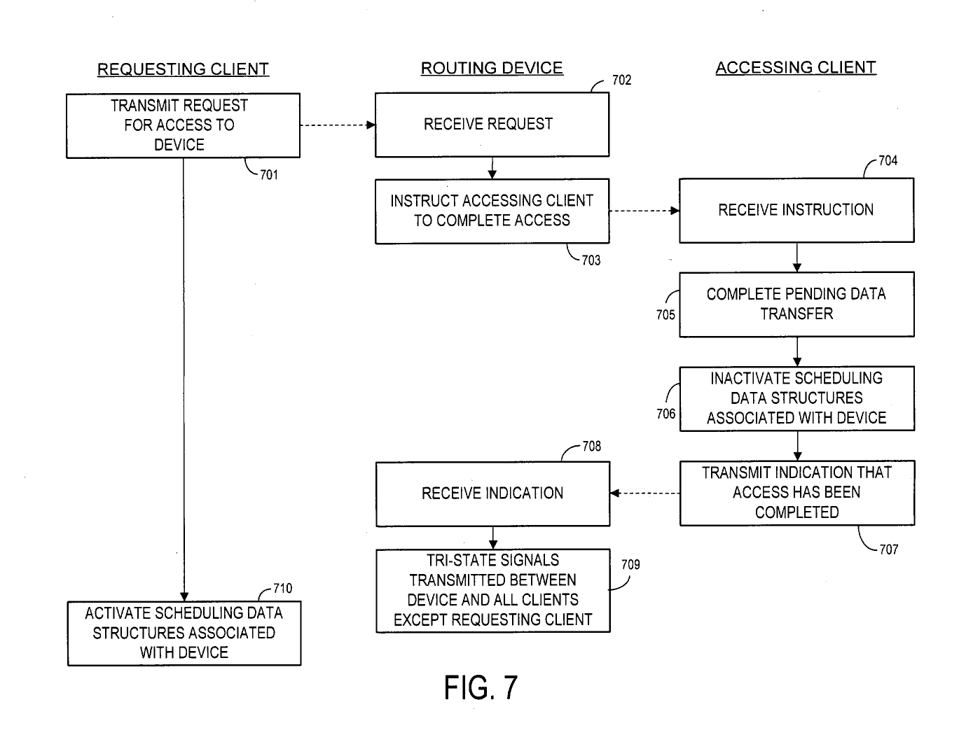

FIG. 7 is a diagram of a process to provide such shared access according to some embodiments. The process may be performed by hardware and/or software of a requesting client, a routing device, and an accessing client as shown in FIG. 7. In some embodiments, the steps that are executed by the requesting client and the accessing client may be embodied in software of respective device drivers corresponding to the shared peripheral device, while the steps that are executed by the routing device may be embodied in software of a management application stored in memory 62. The software may be read from a computer-readable medium such as a floppy disk, a CD-ROM, a DVD-ROM, a ZipTm disk, a magnetic tape, or a signal, and a memory, and executed by a controller of the appropriate device.

The FIG. 7 process will be described below with respect to a specific example according to some embodiments. Initially, it will be assumed that peripheral device 40 is being accessed by client device 35 prior to 701. In 701, client device 30 of system 110 transmits a request to access peripheral device 40 to routing device 20 via backplane interface 58. The request is received by routing device 20 via backplane interface 63 in 702.

Next, in 703, routing device 20 instructs client device 35 to complete access to the device. The instruction is received over a backplane interface of client device 35 in 704. Accordingly, client device 35 completes any pending data transfers with peripheral device 40 in 705.

Client device 35 inactivates scheduling data structures that are associated with peripheral device 40 in 706. In this regard, client device 35 according to some embodiments maintains scheduling data structures including a Frame List, Transfer Descriptors, and Queue Heads. A software driver of USB controller 57 uses these structures to construct a schedule of transactions to execute.

Registers of USB controller 57 specify a starting memory address of the Frame List. The Frame List is an array of records, each of which represents a window of time corresponding to a frame. Accordingly, a record of the Frame List provides a reference to transactions that should be executed during a corresponding frame.

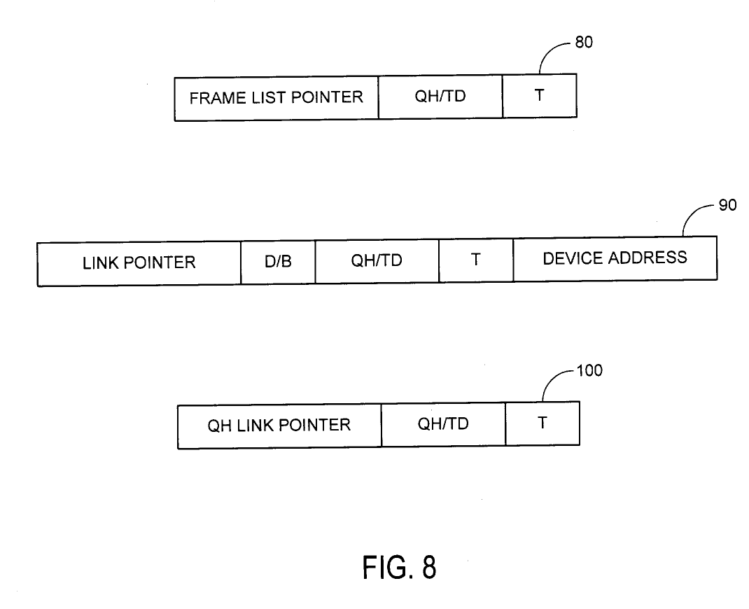

FIG. 8 shows a representation of Frame List record 80. Record 80 corresponds to a frame and includes a Frame List pointer, a Queue Head/Transfer Descriptor flag, and a Terminate flag. The Frame List pointer directs USB controller 57 to a first item in a schedule that corresponds to the frame. The Queue Head/Transfer Descriptor flag indicates whether the item is a Transfer Descriptor or a Queue Head. Such an indication allows USB controller 57 to properly process the item after fetching the item. Terminate flag indicates whether the schedule corresponding to the frame is valid. As a result, all scheduling data structures associated with the frame may be inactivated in step 706 by setting the Terminate flag to TRUE.

FIG. 8 also shows a representation of Transfer Descriptor 90. Transfer Descriptor 90 includes a link pointer to another Transfer Descriptor or Queue Head, and a depth/breadth flag to indicate whether USB controller 57 should process a next transaction in a queue to which Transfer Descriptor 90 belongs (execution by depth), or should start a new queue (execution by breadth). Transfer Descriptor 90 also includes a Queue Head/Transfer Descriptor flag and a Terminate flag such as those described above. Moreover, record 90 specifies a device address that identifies a peripheral device to which record 90 is associated. Therefore, Transfer Descriptors associated with a peripheral device may be inactivated in step 706 by identifying Transfer Descriptors that include the device's address and by setting the Terminate flag of the identified Descriptors to TRUE. Alternatively, the identified Transfer Descriptors may be inactivated by removing them from their memory locations.

Queue Head 100 of FIG. 8 includes a Queue Head link pointer, a Queue Head/Transfer Descriptor flag, and a Terminate flag. The Queue Head link pointer identifies a next data structure in a queue to which record 100 belongs, and the remaining flags are used as described above. Again, a queue of scheduling data structures may be inactivated in step 706 by setting a Terminate flag of a corresponding Queue Head to TRUE, or by deleting the Queue Head from its memory location.

The above-mentioned UHCI Design Guide provides further details of the USB scheduling data structures. It will be noted that each of the scheduling data structures described above may include more or fewer fields than those shown. Moreover, some embodiments utilize data structures different from those described, and may inactivate such data structures in different manners. More specifically, embodiments of the invention are not limited to USB-type scheduling data structures.

Returning to FIG. 7, client device 35 transmits an indication to routing device 20 in 707. The indication indicates that access to peripheral device 40 has been completed. The indication is received by routing device 20 in 708. Next, in 709, routing device 20 operates routing logic 21 to tri-state device signals transmitted between peripheral device 40 and all clients other than the requesting clients. In the present example, routing logic 21 tri-states the device signal transmitted between peripheral device 40 and client device 35.

Client device 30 activates scheduling data structures associated with peripheral device 40 in 710. Activation may comprise setting Terminate flags of existing Queue Heads and/or Transfer Descriptors that are associated with peripheral device 40 to FALSE, and/or by creating new Queue Heads and/or Transfer Descriptors that are associated with peripheral device 40.

The several embodiments described herein are solely for the purpose of illustration. Embodiments may include any currently or hereafter-known versions of the elements described herein. Therefore, persons skilled in the art will recognize from this description that other embodiments may be practiced with various modifications and alterations.

What is claimed is:

1. A method comprising:
receiving a request to provide a first client with access to a device, the device being accessed by a second client; and
tri-stating a device signal transmitted between the device and the second client.

2. A method according to claim 1, further comprising:
instructing the second client to complete access to the device; and
receiving an indication that the second client has completed access to the device.

3. A method according to claim 1, wherein the device is coupled to a plurality of clients, and further comprising:
tri-stating a device signal transmitted between the device and each of the plurality of clients, except for a device signal transmitted between the device and the first client.

4. A method according to claim 1, wherein the device and the second client communicate via a client-initiated protocol.

5. A method according to claim 4, wherein the client-initiated protocol is the Universal Serial Bus protocol.

6. A medium storing processor-executable program code, the program code comprising:
code to receive a request to provide a first client with access to a device, the device being accessed by a second client; and
code to tri-state a device signal transmitted between the device and the second client.

7. A medium according to claim 6, the program code further comprising:
code to instruct the second client to complete access to the device; and
code to receive an indication that the second client has completed access to the device.

8. A medium according to claim 6, wherein the device is coupled to a plurality of clients, the program code further comprising:
code to tri-state a device signal transmitted between the device and each of the plurality of clients, except for a device signal transmitted between the device and the first client.

9. A routing device to:
receive a request to provide a first client with access to a device, the device being accessed by a second client; and
tri-state a device signal transmitted between the device and the second client.

10. A routing device according to claim 9, the management device to:
instruct the second client to complete access to the device; and
receive an indication that the second client has completed access to the device.

11. A routing device according to claim 9, wherein the device is coupled to a plurality of clients, the device further to:
tri-state a device signal transmitted between the device and each of the plurality of clients, except for a device signal transmitted between the device and the first client.

12. A system comprising:
a peripheral device;
a plurality of client devices in communication with the peripheral device; and
a routing device to tri-state a device signal transmitted between the peripheral device and all but one of the plurality of client devices.

13. A system according to claim 12, the routing device to receive a request to provide the one of the plurality of client devices with access to the peripheral device.

14. A system according to claim 13, the one of the plurality of client devices to issue the request.

15. A system according to claim 13, the routing device to instruct a second one of the plurality of client devices to complete access to the peripheral device.

16. A system according to claim 15, the second one of the plurality of client devices to inactivate scheduling data structures associated with the peripheral device.

17. A system according to claim 16, the second one of the plurality of client devices to indicate to the routing device that access to the peripheral device is complete.

18. A system according to claim 12, wherein the routing device comprises:
routing logic to tri-state the device signal transmitted between the peripheral device and all but one of the plurality of client devices; and
a management component to provide the routing logic with an indication of the one of the plurality of client devices.

19. A system according to claim 18, wherein the management component comprises:
a controller; and
a memory storing process steps that are executable by the controller to provide the routing logic with the indication of the one of the plurality of client devices.

20. A device comprising:
routing logic to tri-state a device signal between a peripheral device and all but one of a plurality of client devices;
a controller coupled to the routing logic; and
a memory storing program code executable by the controller to receive a request to provide the one client device with access to the peripheral device, the peripheral device being accessed by a second client device; and to provide the routing logic with an indication of the one client device.

21. A device according to claim 20, the program code further executable to:
instruct the second client device to complete access to the peripheral device.

22. A blade server management module comprising:
routing logic to tri-state a signal transmitted between a Universal Serial Bus device and all but one of a plurality of blade servers;
a controller coupled to the routing logic; and
a Double Data Rate memory storing program code executable by the controller to receive a request to provide the one blade server with access to the Universal Serial Bus device, the Universal Serial Bus device being accessed by a second blade server; and to provide the routing logic with an indication of the one blade server.

23. A blade server management module according to claim 22, the program code further executable to:
instruct the second blade server to complete access to the Universal Serial Bus device.
